(19) United States
(12) Patent Application Publication
(10) Pub. No.: US 2004/0010931 A1
(43) Pub. Date: Jan. 22, 2004

(54) Shoe dryer

(76) Inventor: Oleg Naljotov, Brooklyn, NY (US)

Correspondence Address: OLEG NALJOTOV, 1975 84 str AP# B2, BROOKLYN, NY, 11214, US

(21) Appl. No.: 10/143,694

(22) Filed: Jul. 19, 2002

(51) Int. Cl. F26B 25/00

(52) U.S. Cl. 34/104; 34/90

(57) ABSTRACT

Shoe dryer is electronic device which allows drying a shoe (see picture 1). Shoe dryer have elements:

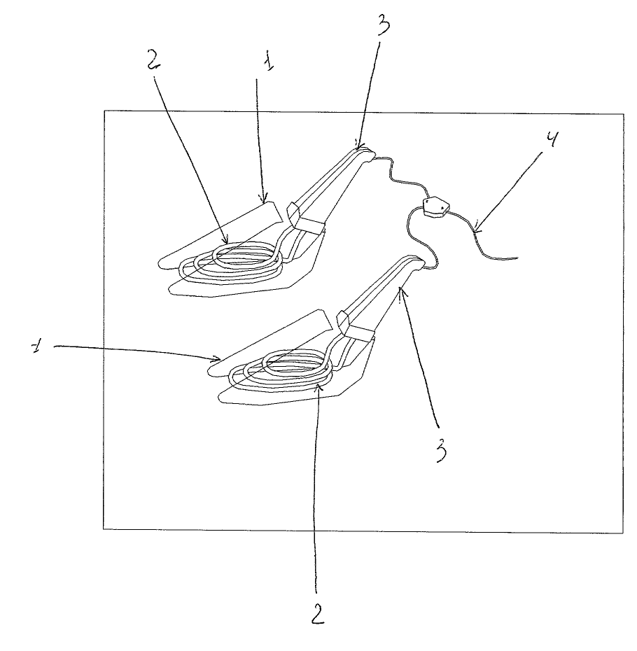

2—Heater element,

1—Shoe shape holder,

3—Handle,

4—Power supply.

Shoe dryer allows drying a shoe in period of 1-6 hours. Heater element temperature should be F140-F160.

Also temperature regulator can be added to shoe dryer.

Shoe dryer is electronic device which allows drying a shoe (see picture 1).

Shoe dryer have elements:

2—Heater element,

1—Shoe shape holder,

3—Handle,

4—Power supply.

Shoe dryer allows drying a shoe in period of 1-6 hours. Heater element temperature should be F140-F160.

Also temperature regulator can be added to shoe dryer.

What I claim as my invention is: “Shoe dryer”.

1. Shoe dryer is electronic device which allows drying a shoe.
